(19) United States
(12) Patent Application Publication
(10) Pub. No.: US 2004/0033193 A1
(43) Pub. Date: Feb. 19, 2004

(54) Method for hydrogen production

(76) Inventor: Ping Chen, Tabor Heights (CN)

Correspondence Address: BIRCH STEWART KOLASCH & BIRCH, PO BOX 747, FALLS CHURCH, VA, 22040-0747, US

(21) Appl. No.: 10/332,199

(22) PCT Filed: Jun. 29, 2001
(86) PCT No.: PCT/SG01/00137

(30) Foreign Application Priority Data
Jul. 7, 2000 (SG) 200003794

(51) Int. Cl. C01B 3/26

(52) U.S. Cl. 423/658.2; 423/651

(57) ABSTRACT

The present work provides a new route for production of hydrogen via water and preformed carbon materials at a relatively low temperature. The preformed carbon materials comprise carbon nanotubes or nanofibers bonded to a transition metal and are obtained by the catalytic decomposition of hydrocarbons in a reductive atmosphere in the presence of the transition metal catalyst. Experimental results demonstrate that the transition metal bonded to the carbon nanotubes or nanofibers has a high activity for the production of hydrogen at temperatures around 450° C.

### FIELD OF THE INVENTION

This invention relates to an economically viable method for producing hydrogen by the reaction between water and preformed carbon material.

### DESCRIPTION OF THE RELATED ART

Hydrogen is one of the most promising energy sources for the new century, especially in view of the great progress made in the field of hydrogen storage in the last three years. It can be foreseen in the near future that the utilization of hydrogen as an energy source will be on the rise, and as such, the need for finding new and economically viable sources of hydrogen is urgent.

In the present time, there are four main processes for producing hydrogen: (1) natural gas-water reforming process; (2) coal-gasification; (3) heavy oil-partial oxidation; and (4) water electrolysis.

In the natural gas-water reforming process, natural gas and steam are co-fed into a fixed bed reactor. The catalyst, which is usually a nickel based composition, is placed in the reactor. The reaction is carried out at a temperature of between 700-900° C. Hydrogen, CO and small amounts of CO₂ are produced. The CO which is produced from this reaction, is forwarded to a shift reactor wherein the CO reacts with water at 300 to 500° C. to produce hydrogen and carbon dioxide (also known as the water-gas shift reaction). Currently, this is the dominant process for producing hydrogen used in industry.

In the coal-gasification process, coal, water and oxygen are used as the feed stock. The operating temperature normally surpasses 1200° C. Both hydrogen and carbon monoxide are produced in the reaction. In order to increase the yields of hydrogen, the carbon monoxide is fed into a shift reactor when the carbon monoxide reacts with water to form hydrogen and carbon dioxide. The major reactions are as follows:

coal+O₂→CO+heat;

coal+H₂O+heat→H₂+CO; and

CO+H₂O→CO₂+H₂(water-gas shift reaction).

Since hydrocarbons which are heavier than naphtha cannot be used directly under the water reforming process to produce hydrogen, the heavy oil-partial oxidation process has been conceived. In the heavy oil-partial oxidation process, heavy oil is allowed to react with a mixture of oxygen and water in the presence of a catalyst at a temperature of 600° C. This reaction will also occur without a catalyst at a temperature of above about 1100° C.

The electrolysis of water is suitable only where cheap electricity is available. In this process, hydrogen is produced by the direct pyrolysis of water in a battery cell where hydrogen and oxygen are the products.

2H₂O+2e⁻→H₂+2OH⁻—cathode reaction

2OH⁻→½O₂+H₂O—anode reaction

H₂O→H₂+½O₂—cell reaction

The cost of this process is comparatively higher than the others, however there is research being performed on the development of more efficient elements.

In addition to the above four methods for producing hydrogen, there are several technologies in development which are promising. One of them is the thermal cracking of natural gas which has the following reaction scheme CH₄→C+2H₂. The operating temperature is around 800° C. with hydrogen and carbon black formed as the product. The carbon black can be further used as fuel or as a component in ink or paint. It has been suggested that the thermal cracking of natural gas process is competitive with the natural gas-steam reforming process.

Each of the above described methods for producing hydrogen is too inefficient and costly to compete with other sources of energy currently available. Thus there is a need for a process for producing hydrogen which is more economical.

### BRIEF SUMMARY OF THE INVENTION

The present invention, in part, is drawn to a method for producing hydrogen comprising contacting water with a preformed carbon material. This preformed carbon material is prepared by the decomposition of a hydrocarbon in the presence of a metal catalyst.

The invention is also drawn to a method of producing hydrogen comprising catalytically decomposing hydrocarbons to form hydrogen and a preformed carbon material, and a step of contacting water with the preformed carbon material to form hydrogen, CO₂, and CO.

According to one aspect of the invention, most of the preformed carbon material is in the form of carbon nanofibers or nanotubes with catalyst particles attached to one end of the fiber or tube.

Additional features and advantages of the invention will be set forth in the following description, and in part will be apparent from the description, or may be learned by practice of the invention. These variations are considered to be within the scope of the invention.

### BRIEF DESCRIPTION OF THE DRAWINGS

FIG. 1 is a TEM image of the preformed carbon nanofibers or nanotubes; and

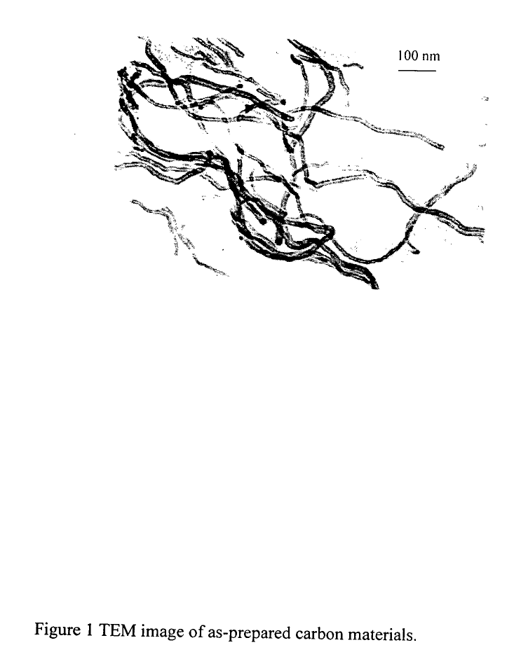

FIG. 2 is a mass spectrum showing the amount of hydrogen, CO, and CO₂ formed at various temperatures.

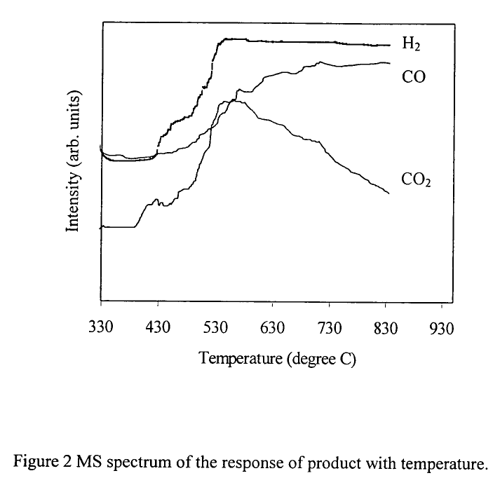

### DETAILED DESCRIPTION OF THE INVENTION

The present invention includes a method for producing hydrogen by the reaction between water and preformed carbon material at a temperature of about 300° C. to about 1000° C. under 0.1 atm to 100 atm pressure. The method further comprises a step of contacting a hydrocarbon with a metal to form the preformed carbon material.

The invention also includes a method of producing hydrogen comprising catalytically decomposing hydrocarbons to form hydrogen and a preformed carbon material, and a step of contacting water with the preformed carbon material to form hydrogen, CO₂, and CO.

The preformed carbon material comprises at least 20 wt % carbon nanotubes or nanofibers bonded to a metal. Preferably, the preformed carbon material comprises at least 50 wt % carbon nanotubes or nanofibers bonded to a metal. In other words, the preformed carbon material has a molar ratio of carbon to metal ranging from 10,000:1 to 1:10. Preferably, the molar ratio of carbon to metal is from 5,000:1 to 100:1.

The metal which is bonded to the carbon nanotubes or nanofibers is a transition metal which optionally contains a support. The transition metal is preferably a member of Group VIII of the periodic table, and the support is preferably selected from the group consisting of alkaline earth oxides, rare earth oxides, alkali oxides, silica, zirconia, yttrium oxide, zeolites, aluminosilicates, alumina, and mixtures thereof. The relative weight ratio of the support to the transition metal is 20:1 to 1:1. Preferably, the transition metal is nickel or cobalt which is supported on either magnesium oxide or lanthanum oxide.

The hydrocarbons useful in the formation of preformed carbon material are selected from the group consisting of alkanes, alkenes, alkynes, aromatics and mixtures thereof. Preferably, the hydrocarbons are C₁-C₁₂ alkanes, C₁-C₁₂ alkenes, C₁-C₆ alkynes, and C₆-C₁₄ aromatic hydrocarbons.

The activity of metals varies depending upon the substrate. For example, Ni or Co has a higher activity using CH₄ whereas Fe has a higher activity when using C₂H₅.

In the step of contacting a hydrocarbon with a metal to form the preformed carbon material, hydrogen is present, and optionally other reductive or inert gases. Preferably, this step is performed in an oxygen-poor atmosphere. More preferably, oxygen is less than 5 wt % of the gas composition.

Once the preformed carbon material is formed, the hydrocarbon feed is discontinued, and the preformed carbon material is exposed to an excess of water thereby forming hydrogen. Under the conditions in which the hydrogen forming step is performed, the water is in the form of steam. The conditions for this step range from 300° C. to about 1000° C. under 0.1 atm to 100 atm. Preferably, the temperature ranges from 400-900° C. and the pressure is 1 to 80 atm.

Both the step of forming the preformed carbon material and the catalytic decomposition of water step can be performed in either a batch or continuous process. Preferably, the catalytic decomposition of water step is performed in a continuous process at a flow rate of 1 to 5,000 ml/min-mg carbon. In other words, the flow rate is from 10 of carbon dioxide begins to increase. Hydrogen starts to form at around 450° C., and at 550° C. both carbon dioxide and hydrogen reach an apex. At above 550° C., CO₂ has a continuous slight drop. The composition of the carbon containing products strongly depends on the temperature and H₂O/C ratio. An excess of water favors the formation of carbon dioxide.

It was found that the purified carbon nanotubes or nanofibers having the catalyst particle removed produce very little hydrogen at temperatures around 800° C. whereas the carbon nanotubes or nanofibers of the present invention contained in the catalyst produced more than a hundred liters of hydrogen from 100 milligrams of nickel based catalyst. It is well known that the direct reaction between water and carbonaceous materials (such as water-coal reaction and water-coke) requires temperatures as great as 1200° C. to overcome the high thermodynamic barrier between reactants and products. The dramatic drop in the required reaction temperature of the inventive process is due to the presence of the transition metal attached at one end of the carbon nanotubes.

Without being bound to theory, it is presumed that the electron cloud of the H₂O molecule interacts with the surface of the transition metal based catalyst, and the H—O—H bonding weakens or even breaks. Carbon atoms which are nearby diffused throughout the body or surface of the catalyst particles and react with O to form CO₂ or CO. Subsequently, two H atoms will combine together and form H₂. Low temperatures favor the formation of CO₂ while high temperatures favor CO due to the equilibrium reaction:

2CO [symbol] C+CO₂+heat.

In the first step of forming the preformed carbon materials, the decomposition of the hydrocarbons is carried out at 300 to 1000° C., more preferably from 400 to 900° C. The pressure of the decomposition reaction is from 0.1 to 100 atm, and preferably from 1 to 80 atm.

The amount of hydrogen gas used in the first step is very small compared to the amount of hydrogen gas produced in the second step. From 100 milligrams of nickel based catalyst, 100 milliliters is required to reduce the catalyst, but from the same 100 milligrams of reduced catalyst containing tens of grams of carbon nanofibers, over 100 liters of hydrogen are produced with steam. It has been observed that the carbon material is consumed in the reaction based on the following observations. First there is the production of the carbon containing byproducts CO₂ and CO. Second, the weight of the carbon sample dramatically drops after the reaction.

The following specific examples are provided to illustrate the invention. It will be understood, however, that the specific details given in each example have been selected for purposes of illustration and are not to be construed as the limitations of the invention.

### EXAMPLE 1

In the first step, 30 milligrams of Ni catalyst is supported on magnesium oxide support. The Ni/MgO catalyst is placed into a reactor. Hydrogen is blown over the Ni/MgO catalyst as the temperature is raised to 700° C. The hydrogen gas is discontinued and CH₄ gas is blown over the catalyst for about half an hour, thereby producing the preformed carbon material containing mostly carbon nanofibers or nanotubes bonded to the Ni/MgO catalyst at the ends of the fibers.

In the same reactor, CH₄ is discontinued and an excess of steam is blown over the preformed carbon material at 550° C. thereby producing hydrogen, CO₂ and CO.

### EXAMPLE 2

50 milligrams of a pre-reduced Co/MgO catalyst are placed into a reactor. The temperature is raised to 600° C. and C₂H₄ is added for about one hour. Both hydrogen and the preformed carbon materials are produced. The C₂H₄ is discontinued and steam is added above the preformed carbon materials containing the Co/MgO catalyst. The temperature is raised to 550° C. Hydrogen, CO and CO₂ are obtained.

I claim:

1. A method for producing hydrogen comprising a step of contacting water with a preformed carbon material at a temperature of about 300° C. to about 1000° C. under 0.1 atm to 100 atm pressure.

2. The method according to claim 1, further comprising a step of contacting a hydrocarbon with a metal to form the preformed carbon material.

3. The method according to claim 1 or 2, wherein the preformed carbon material comprises at least 20 wt % carbon nanotubes or nanofibers bonded to a metal.

4. The method according to claim 2, wherein the hydrocarbons are selected from the group consisting of alkanes, alkenes, alkynes, aromatics and mixtures thereof.

5. The method according to claim 2, wherein the metal is a transition metal which optionally contains a support.

6. The method according to claim 5, wherein the transition metal is a member of Group VIII of the periodic table.

7. The method according to claim 5, wherein the support is selected from the group consisting of alkaline earth oxides, rare earth oxides, alkali oxides, silica, zirconia, yttrium oxide, zeolites, aluminosilicates, alumina, and mixtures thereof.

8. The method according to claim 1, wherein the temperature is 400-900° C.

9. The method according to claim 1, wherein the pressure is 1 to 80 atm.

10. The method according to claim 1, wherein the hydrogen gas is produced from the reation between water and preformed carbon material.

11. The method according to claim 1, wherein the hydrogen is produced in a batch or continuous process.

12. The method according to claim 11, wherein hydrogen is produced in a continuous process at a flow rate of 1 to 5,000 ml/min.

13. The method according to claim 4, wherein the hydrocarbons are C₁-C₁₂ alkanes, C₁-C₁₂ alkenes, C₁-C₆ alkynes, and C₆-C₁₄ aromatic hydrocarbons.

14. The method according to claim 6, wherein the metal is nickel or cobalt which is supported on magnesium oxide or Lathanum oxide.

15. The method according to claim 2, wherein the preformed carbon material has a molar ratio of carbon to metal ranging from 10,000:1 to 1:10.

16. The method according to claim 3, wherein the preformed carbon material comprises at least 50 wt % carbon nanotubes or nanofibers bonded to a metal.

17. A method of producing hydrogen comprising catalytically decomposing hydrocarbons to form hydrogen and a preformed carbon material, and a step of contacting water with the preformed carbon material to form hydrogen, CO₂, and CO.

18. The method according to claim 3, wherein the carbon nanofibers or nanotubes are from 2 to 500 nm in diameter and up to 100 microns in length.

19. The method according to claim 2, wherein the step of forming the preformed carbon material is carried out at 300 to 1000° C. and 0.1 to 100 atm.

20. The method according to claim 19, wherein the step of forming the preformed carbon material is carried out at 400 to 900° C. and from 1 to 80 atm.
